(19) United States
(12) Patent Application Publication
(10) Pub. No.: US 2024/0061712 A1
(43) Pub. Date: Feb. 22, 2024

(54) METHOD, APPARATUS, AND SYSTEM FOR CREATING TRAINING TASK ON AI TRAINING PLATFORM, AND MEDIUM

(71) Applicant: Inspur Suzhou Intelligent Technology Co., Ltd., Suzhou (CN)

(72) Inventor: Huixing LIU, Suzhou (CN)

(73) Assignee: Inspur Suzhou Intelligent Technology Co., Ltd., Suzhou (CN)

(21) Appl. No.: 18/270,443

(22) PCT Filed: Sep. 29, 2021
(86) PCT No.: PCT/CN2021/121907

§ 371 Date: Jun. 29, 2023

(30) Foreign Application Priority Data
Jun. 9, 2021 (CN) 202110642460.4

(51) Int. Cl. G06F 9/50

(52) U.S. Cl. CPC G06F 9/5027; G06F 9/5016

(57) ABSTRACT

A method, apparatus, and system for creating a training task on an AI training platform, and a computer-readable storage medium. The method includes: dividing nodes of the AI training platform into a plurality of virtual groups in advance, dividing a preset quota of disk space from each node to form a shared storage space of a virtual group, receiving training task configuration information inputted by a user, and determining task configuration conditions according to the training task configuration information; and determining whether there are first nodes satisfying the task configuration conditions among the nodes of the AI training platform, if so, selecting a target node from the first nodes according to a preset filtering method, creating a corresponding training task on the target node, and caching a training dataset obtained from a remote data center into an independent storage space of the target node, and recording a corresponding storage path.

This application claims priority to Chinese Patent Application No. 202110642460.4, filed on Jun. 9, 2021 in China National Intellectual Property Administration and entitled “Method, Apparatus, and System for Creating Training Task on AI Training Platform, and Medium”, which is hereby incorporated by reference in its entirety.

### FIELD

Embodiments of the present application relate to the technical field of artificial intelligence, in particular to a method, apparatus, and system for creating a training task on an AI training platform, and a computer-readable storage medium.

### BACKGROUND

With the development of AI (Artificial Intelligence) technology, the AI technology has been applied in increasingly wide fields, for example, applied in voice recognition fields and model training of machine translation and the like.

Mass dataset files are used in AI training. An AI training task usually performs multiple epoch (iterative) training on training datasets, and each epoch requires a complete dataset. In addition, when the training task is started, the corresponding training datasets are pulled from a remote center storage to a local disk, and then trained, thereby avoiding waiting for computing resources due to direct access to the remote center storage.

At present, an AI training task is usually created on a node specified by a user. However, when the storage space of the node specified by the user is insufficient, the creation of the AI training task may fail, and the user needs to reselect a specified node, whereby the creation efficiency of the training task is affected and inconvenience is brought to the user.

In view of this, providing a method, apparatus, and system for creating a training task on an AI training platform, and a computer-readable storage medium to solve the foregoing technical problems has become a problem that needs to be solved by those skilled in the art.

### SUMMARY

Embodiments of the present application aim to provide a method, apparatus, and system for creating a training task on an AI training platform, and a computer-readable storage medium, whereby creation efficiency of a training task and user experience might be improved during use.

To solve the foregoing technical problems, an embodiment of the present application provides a method for creating a training task on an AI training platform, including:
dividing nodes of the AI training platform into a plurality of virtual groups in advance according to one or more of switch information of the nodes, local area network information, a total quantity of the nodes, and an application dataset;
dividing a preset quota of disk space from each node to form a shared storage space of each virtual group, where each shared storage space corresponds to a distributed caching system;
receiving training task configuration information inputted by a user, and determining task configuration conditions according to the training task configuration information, the task configuration conditions including a size of a training dataset and a quantity of computing resources;
determining whether there are first nodes satisfying the task configuration conditions among the nodes of the AI training platform, and if so, selecting a target node from the first nodes according to a preset filtering method;
creating a corresponding training task on the target node according to the training task configuration information, and
obtaining the corresponding training dataset from a remote data center according to a remote storage path corresponding to the training dataset in the training task configuration information; and
caching the training dataset into an independent storage space of the target node, and recording a storage path of the training dataset in the independent storage space of the target node, the independent storage space being a remaining disk space divided from the disk space beyond the preset quota of disk space.

In some embodiments, after determining that none of the nodes in the AI training platform satisfy the task configuration conditions, the method further includes:
determining whether there are first virtual groups with shared storage spaces satisfying the size of the training dataset among the virtual groups, and if there are the first virtual groups, determining whether there are second nodes with computing resources satisfying the quantity of computing resources among the first virtual groups;
if there are the second nodes, using the virtual groups corresponding to the second nodes as second virtual groups, and selecting a target virtual group from the second virtual groups; and
when there is one second node in the target virtual group, directly using the second node in the target virtual group as the target node, obtaining the corresponding training dataset from the remote data center through the corresponding distributed caching system, and caching the training dataset into the shared storage space of the target virtual group; or
when there is a plurality of second nodes in the target virtual group, using the second node with a quantity of remaining computing resources closest to the quantity of computing resources in the task configuration conditions among the second nodes in the target virtual group as the target node, obtaining the corresponding training dataset from the remote data center through the corresponding distributed caching system, and caching the training dataset into the shared storage space of the target virtual group.

In some embodiments, the process of determining whether there are first nodes satisfying the task configuration conditions among the nodes of the AI training platform is as follows:
determining whether there are nodes with independent storage spaces satisfying the size of the training dataset among the nodes of the AI training platform, and if so, determining whether there are first nodes with computing resources satisfying the quantity of computing resources among the nodes satisfying the size of the training dataset.

In some embodiments, the process of selecting a target node from the first nodes according to a preset filtering method is as follows:
comparing the remaining independent storage space of each first node with the size of the training dataset, and selecting the first node with the remaining independent storage space closest to the size of the training dataset, as the target node.

In some embodiments, before determining whether there are first nodes satisfying the task configuration conditions among the nodes of the AI training platform, the method further includes:
determining whether the training dataset is cached in the independent storage space of each node of the AI training platform, if so, selecting the target node satisfying the quantity of computing resources from the nodes with the cached training dataset, and creating the training task on the target node; otherwise, determining whether the training dataset is cached in the shared storage space of each virtual group, if so, determining whether there are nodes satisfying the quantity of computing resources from the nodes of the virtual group with the cached training dataset, if so, selecting the target node from the nodes satisfying the quantity of computing resources, and creating the training task on the target node; or if there is no virtual group with the cached training dataset or no node satisfying the quantity of computing resources, performing the step of determining whether there are first nodes satisfying the task configuration conditions among the nodes of the AI training platform.

In some embodiments, after determining whether there are first virtual groups with shared storage spaces satisfying the size of the training dataset among the virtual groups, the method further includes:
if there is no first virtual group, reconfiguring the shared storage space of each virtual group according to the size of the training dataset to update the shared storage space of the virtual group.

In some embodiments, the process of reconfiguring the shared storage space of each virtual group according to the size of the training dataset to update the shared storage space of the virtual group is as follows:
resetting the preset quota according to the size of the training dataset, and reconfiguring the shared storage space of the virtual group according to the new preset quota to update the shared storage space of the virtual group.

In some embodiments, the process of reconfiguring the shared storage space of each virtual group according to the size of the training dataset to update the shared storage space of the virtual group is as follows:
adding a new node to the virtual group according to the size of the training dataset, and dividing a preset quota of disk space from the new node to the shared storage space of the virtual group to update the shared storage space of the virtual group.

An embodiment of the present application correspondingly provides an apparatus for creating a training task on an AI training platform, including:
a first division module, configured to divide nodes of the AI training platform into a plurality of virtual groups in advance according to one or more of switch information of the nodes, local area network information, a total quantity of the nodes, and an application dataset;
a second division module, configured to divide a preset quota of disk space from each node to form a shared storage space of each virtual group, where each shared storage space corresponds to a distributed caching system;
a receiving module, configured to receive training task configuration information inputted by a user, and determine task configuration conditions according to the training task configuration information, the task configuration conditions including a size of a training dataset and a quantity of computing resources;
a determination module, configured to determine whether there are first nodes satisfying the task configuration conditions among the nodes of the AI training platform, and if so, trigger a selection module;
the selection module, configured to select a target node from the first nodes according to a preset filtering method;
a creation module, configured to create a corresponding training task on the target node according to the training task configuration information, and obtain the corresponding training dataset from a remote data center according to a remote storage path corresponding to the training dataset in the training task configuration information; and
a caching module, configured to cache the training dataset into an independent storage space of the target node, and record a storage path of the training dataset in the independent storage space of the target node, the independent storage space being a remaining disk space divided from the disk space beyond the preset quota of disk space.

An embodiment of the present application further provides a system for creating a training task on an AI training platform, including:
a memory, configured to store a computer program; and
a processor, configured to implement the steps of the foregoing method for creating a training task on an AI training platform when executing the computer program.

An embodiment of the present application further provides a computer-readable storage medium, where the computer-readable storage medium stores a computer program, and the steps of the foregoing method for creating a training task on an AI training platform are implemented when the computer program is executed by a processor.

According to the method, apparatus, and system for creating a training task on an AI training platform, and the computer-readable storage medium provided in the embodiments of the present application, nodes of the AI training platform are divided into a plurality of virtual groups in advance according to one or more of switch information of the nodes, local area network information, a total quantity of the nodes, and an application dataset, and a preset quota of disk space is divided from each node to form a shared storage space of each virtual group, where each shared storage space corresponds to a distributed caching system; after training task configuration information inputted by a user is received, task configuration conditions are determined according to the training task configuration information, where the task configuration conditions include a size of a training dataset and a quantity of computing resources; then first nodes satisfying the task configuration conditions are determined and selected from the nodes of the AI training platform, a target node is selected from the first nodes according to a preset filtering method, a corresponding training task is created on the target node, the corresponding training dataset is obtained from a remote data center according to a remote storage path corresponding to the training dataset in the training task configuration information; the training dataset is cached into an independent storage space of the target node, and a storage path of the training dataset in the independent storage space of the target node is recorded; therefore, the present application might avoid a problem of task creation failure caused by insufficient storage space of a specified node during use, and is beneficial to improving creation efficiency of a training task and user experience.

### BRIEF DESCRIPTION OF THE DRAWINGS

In order to describe the technical solutions in the embodiments of the present application more clearly, drawings required to be used in the existing art and the embodiments will be briefly introduced below. Apparently, the drawings in the illustration below are some embodiments of the present application. Those ordinarily skilled in the art also might obtain other drawings according to the provided drawings without creative work.

FIG. 1 is a schematic flow chart of a method for creating a training task on an AI training platform according to an embodiment of the present application;

FIG. 2 is a schematic diagram of virtual groups of an AI training platform according to an embodiment of the present application; and

FIG. 3 is a schematic structural diagram of an apparatus for creating a training task on an AI training platform according to an embodiment of the present application.

### DETAILED DESCRIPTION

Embodiments of the present application provide a method, apparatus, and system for creating a training task on an AI training platform, and a computer-readable storage medium, which are beneficial to improving creation efficiency of a training task and user experience during use.

In order to make the objectives, technical solutions and advantages of the embodiments of the present application clearer, the technical solutions in the embodiments of the present application will be described clearly and completely below in conjunction with the accompanying drawings in the embodiments of the present application. Apparently, the described embodiments are part of the embodiments of the present application, not all of them. Based on the embodiments of the present application, all other embodiments obtained by those skilled in the art without creative work shall fall within the protection scope of the present application.

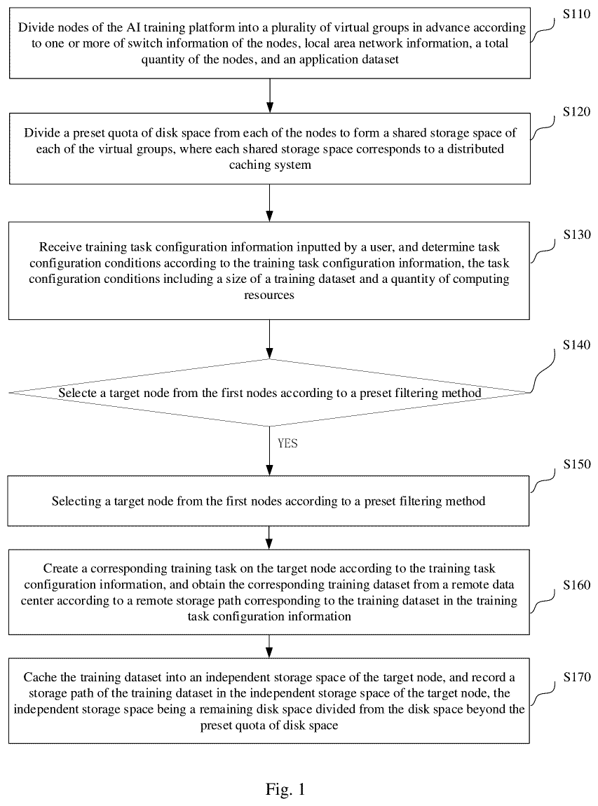

Refer to FIG. 1. FIG. 1 is a schematic flow chart of a method for creating a training task on an AI training platform according to an embodiment of the present application. The method includes:

S110: dividing nodes of the AI training platform into a plurality of virtual groups in advance according to one or more of switch information of the nodes, local area network information, a total quantity of the nodes, and an application dataset.

S120: dividing a preset quota of disk space from each node to form a shared storage space of each virtual group, where each shared storage space corresponds to a distributed caching system.

It should be noted that in practical applications, when a training dataset is too large, in order to avoid the limited storage space of a single node, the large training dataset cannot be cached, and a dataset file might be pulled from a remote data center in an AI training process, resulting in a low training speed. In the embodiment of the present application, nodes in the AI platform may be divided into a plurality of virtual groups in advance, each virtual group has a shared storage space, the shared storage space is composed of a portion of a storage space of each node in the virtual group, and each shared storage space may be managed by a corresponding distributed caching system, where when a training dataset is too large and the storage space of a single node cannot meet a caching requirement of the training dataset, a virtual group that meets the requirement may be selected to cache the training dataset into the shared storage space of the virtual group. For each node in each virtual group, a portion of a disk space of the node is used as a shared storage space of the virtual group, and the remaining disk space is used as an independent storage space of the node.

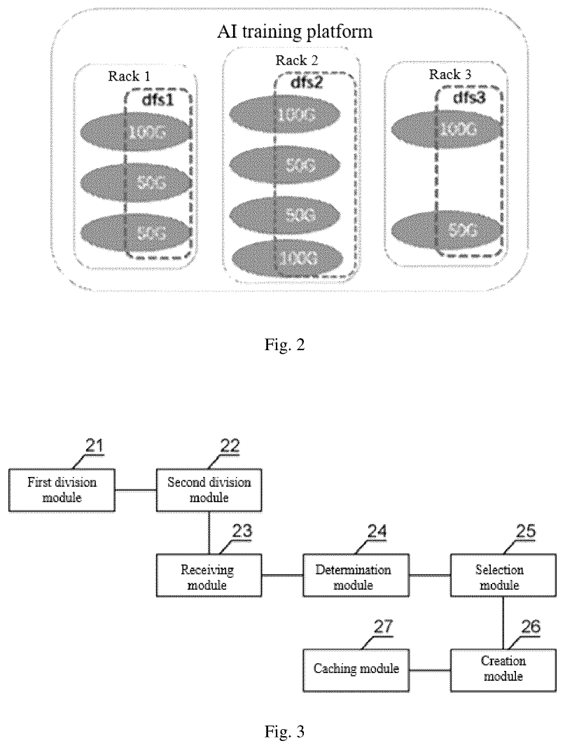

In some embodiments, nodes of the AI training platform may be divided into a plurality of virtual groups in advance according to one or more of switch information (or rack information) of the nodes, local area network information, a total quantity of the nodes, and an application dataset. For example, nodes that are located in a same local area network and disposed on a same switch (or rack) may be divided into a virtual group, or some nodes may be selected according to a size of the application dataset and divided into a virtual group. For each node in each virtual group, a preset quota of disk space is divided as a shared storage space of the virtual group. In some embodiments, a preset proportion of disk space may be used as the shared storage space, for example, 50% of disk space is used as the shared storage space. A total quota of shared storage space of a virtual group is a sum of quotas of nodes in the virtual group. After each shared storage space of each virtual group is determined, a distributed caching system may be further allocated for each shared storage space. Each shared storage space may be managed through each distributed caching system. As shown in FIG. 2, three nodes located on a rack 1 in the AI training platform are divided into a group, 100 G, 50 G, and 50 G of disk spaces are divided separately from the nodes as a shared storage space 1, and the shared storage space 1 is managed through a distributed caching system dfs1; four nodes located on a rack 2 are divided into a group, 100 G, 50 G, 50 G, and 100 G of disk spaces are divided separately from the nodes as a shared storage space 2, and the shared storage space 2 is managed through a distributed caching system dfs2; and two nodes located on a rack 3 are divided into a group, 100 G and 50 G of disk spaces are divided separately from the nodes as a shared storage space 3, and the shared storage space 3 is managed through a distributed caching system dfs3.

In some embodiments, the distributed caching system may be mounted to each node in the virtual group in a fuse manner, and the distributed caching system may access data cached in the shared storage space through a resd interface of POSIX, without modifying an underlying application, to implement subsequent task training.

S130: receiving training task configuration information inputted by a user, and determining task configuration conditions according to the training task configuration information, the task configuration conditions including a size of a training dataset and a quantity of computing resources.

It should be noted that in practical applications, when the user needs to create an AI training task, the user may input training task configuration information on the AI training platform, where the training task configuration information may include training dataset information, computing resource information, training scripts, a computing framework, a remote storage path of training data in a remote center, and the like, the training dataset information including a size of a training dataset, a name of training data, a storage location of the training data in the remote center, and the computing resource information including a quantity of cpu computing resources, a quantity of gpu computing resources, and the like. The present application may determine the training task configuration conditions according to the training task configuration information inputted by the user, that is, determine the size of the training dataset and the quantity of computing resources.

S140: determining whether there are first nodes satisfying the task configuration conditions among the nodes of the AI training platform, and if so, entering S150.

In some embodiments, after the task configuration conditions are determined, the nodes in the AI platform may be filtered. In some embodiments, sizes of remaining independent storage spaces and computing resources of the nodes may be filtered to determine each first node satisfying the task configuration conditions, that is, the size of the remaining independent storage space of the node satisfies the size of the training dataset, and the size of idle computing resources of the node satisfies the quantity of computing resources required by the task.

In some embodiments, it may be first determined whether the size of the remaining independent storage space of each node satisfies the size of the training dataset, and if so, each first node satisfying the quantity of computing resources may be selected from each node with remaining independent storage space satisfying the size of the training dataset.

S150: selecting a target node from the first nodes according to a preset filtering method.

In some embodiments, when there is one first node satisfying the task configuration conditions, the first node is directly used as the target node. If there is a plurality of first nodes, the target node may be selected from the first nodes according to a best fit algorithm. In some embodiments, the first node with the remaining independent storage space closest to the training dataset in size may be selected from the first nodes as the target node according to the size of the training dataset. For example, there are three first nodes, their remaining independent storage spaces are 550M, 600M, and 800M, respectively, the size of the training dataset is 500M, the first node with the remaining independent storage space of 550M may be used as the target node, and the first node of 600M may be selected when there is a larger training dataset (such as 580M), whereby the storage space of each node might be utilized and waste of node storage space might be effectively avoided.

S160: creating a corresponding training task on the target node according to the training task configuration information, and obtaining the corresponding training dataset from a remote data center according to a remote storage path corresponding to the training dataset in the training task configuration information.

In some embodiments, after the target node is selected, the training task may be created on the target node according to the training task configuration information inputted by the user, and then the corresponding training dataset may be obtained from the remote data center according to the remote storage path of training data stored in the remote data center.

S170: caching the training dataset into an independent storage space of the target node, and recording a storage path of the training dataset in the independent storage space of the target node, the independent storage space being a remaining disk space divided from the disk space beyond the preset quota of disk space.

In some embodiments, after the training dataset is obtained from the remote data center, the training dataset may be cached into the independent storage space of the target node, and the storage path of the training dataset on the target node may be recorded for subsequent training of an AI task, where the training dataset located in the independent storage space of the target node might be used when the AI training task established on the node is trained. The present application may automatically select the target node satisfying the task configuration conditions from the nodes according to the training task configuration information to create a training task and cache a training dataset, which might avoid a problem of task creation failure caused by insufficient storage space of a specified node and is conducive to improving creation efficiency of a training task.

Further, the process of determining whether there are first nodes satisfying the task configuration conditions among the nodes of the AI training platform in S140 may be as follows:
determining whether there are nodes with independent storage spaces satisfying the size of the training dataset among the nodes of the AI training platform, and if so, determining whether there are first nodes with computing resources satisfying the quantity of computing resources among the nodes satisfying the size of the training dataset.

In some embodiments, whether the remaining storage space of the independent storage space of each node satisfies a requirement for the size of the training dataset may be first determined. If there are nodes that satisfy the requirement, whether idle computing resources in these nodes satisfy a requirement for the quantity of computing resources in the training task are further determined from these nodes, and the nodes with the idle computing resources satisfying the requirement for the quantity of computing resources in the training task are used as the first nodes.

Correspondingly, the process of selecting a target node from the first nodes according to a preset filtering method in S150 may be as follows: comparing the remaining independent storage space of each first node with the size of the training dataset, and selecting the first node with the remaining independent storage space closest to the size of the training dataset, as the target node.

Further, after determining that none of the nodes in the AI training platform satisfy the task configuration conditions, the method may further include:
determining whether there are first virtual groups with shared storage spaces satisfying the size of the training dataset among the virtual groups, and if there are the first virtual groups, determining whether there are second nodes with computing resources satisfying the quantity of computing resources among the first virtual groups;
if there are the second nodes, using the virtual groups corresponding to the second nodes as second virtual groups, and selecting a target virtual group from the second virtual groups; and
when there is one second node in the target virtual group, directly using the second node in the target virtual group as the target node, obtaining the corresponding training dataset from the remote data center through the corresponding distributed caching system, and caching the training dataset into the shared storage space of the target virtual group; or
when there is a plurality of second nodes in the target virtual group, using the second node with a quantity of remaining computing resources closest to the quantity of computing resources in the task configuration conditions among the second nodes in the target virtual group as the target node, obtaining the corresponding training dataset from the remote data center through the corresponding distributed caching system, and caching the training dataset into the shared storage space of the target virtual group.

That is, after S140 is executed to determine whether there are first nodes satisfying the task configuration conditions among the nodes of the AI training platform and determine that none of the nodes in the AI training platform satisfy the task configuration conditions, when it is determined that the remaining space of the independent storage space of each node does not satisfy the requirement for the size of the training dataset, it may be determined that none of the nodes satisfy the task configuration conditions, indicating that the training dataset is large and cannot be cached into the independent storage space of any node. Therefore, it may be further determined whether the remaining space of the shared storage space in each virtual group satisfies the requirement for the size of the training dataset, each first virtual group is determined if the remaining space satisfies the requirement, then second nodes with idle computing resources satisfying the quantity of computing resources of the training task are selected from the nodes in each first virtual group, and the virtual groups where the second nodes are located are determined as the second virtual groups. In order to improve the utilization of the shared storage space, the target virtual group may be selected from the second virtual groups. In some embodiments, the remaining space of the shared storage space of each second virtual group may be compared with the size of the training dataset, and the second virtual group with the remaining space of the shared storage space closest to the training data and the size is selected as the target virtual group. When there is one second node in the target virtual group, the second node in the target virtual group is used as the target node, then the AI training task is created on the target node, the corresponding training dataset is obtained from the remote data center through the distributed caching system in the target virtual group, and then the training dataset is stored into the shared storage space of the target virtual group. If there is a plurality of second nodes in the target virtual group, the quantity of remaining computing resources in each second node of the target virtual group may be compared with the quantity of computing resources in the task configuration condition (namely, the quantity of computing resources required by the training task), the second node with the quantity of remaining computing resources closest to the quantity of computing resources in the task configuration conditions among the second nodes is used as the target node, then the corresponding training dataset is obtained from the remote data center through the distributed caching system, and the training dataset is stored into the shared storage space of the target virtual group.

It should also be noted that when the remaining space of the shared storage space of each virtual group cannot satisfy the size of the training dataset, or when each node in each second virtual group does not satisfy the quantity of computing resources, a reminder message about training task creation failure is returned.

In some embodiments, the reminder message may include reminders such as insufficient storage space. The user may alternatively input node operation instructions and manage the corresponding nodes according to the node operation instructions, including deleting the corresponding dataset currently cached in the node storage space and the like.

In addition, after each AI training task is created and trained, the cpu computing resources and gpu computing resources used when the AI training task is trained may alternatively be recovered and included in the total quantity of idle computing resources of the corresponding nodes, so as to select the corresponding nodes to create an AI training task next time.

Further, before determining whether there are first nodes satisfying the task configuration conditions among the nodes of the AI training platform in S140, the method may further include:
determining whether the training dataset is cached in the independent storage space of each node of the AI training platform, if so, selecting the target node satisfying the quantity of computing resources from the nodes with the cached training dataset, and creating the training task on the target node; otherwise, determining whether the training dataset is cached in the shared storage space of each virtual group, if so, determining whether there are nodes satisfying the quantity of computing resources from the nodes of the virtual group with the cached training dataset, if so, selecting the target node from the nodes satisfying the quantity of computing resources, and creating the training task on the target node; or if there is no virtual group with the cached training dataset or no node satisfying the quantity of computing resources, performing the step of determining whether there are first nodes satisfying the task configuration conditions among the nodes of the AI training platform.

It should be noted that after the training task configuration information inputted by the user is received and the task configuration conditions are determined according to the training task configuration information, whether the training dataset is cached in the independent storage space of each node of the AI training platform may be first determined, then if there are nodes with the cached training dataset, determining whether there is the target node with computing resources satisfying the quantity of computing resources among the nodes with the cached training dataset, and if so, the training task is directly created on the target node; or if the training dataset is not cached in the independent storage space of each node of the AI training platform, whether the training dataset is cached in the shared storage space of each virtual group is further determined, if so, the virtual group is determined, then whether there are nodes with computing resources satisfying the quantity of computing resources among the nodes of the virtual group is determined, if so, one node may be selected from these nodes as the target node, in some embodiments, the node with the quantity of remaining computing resources closest to the quantity of computing resources required by the training task may be selected from these nodes as the target node, and the training task is created on the target node, so as to create training tasks using the same training dataset in the same virtual group and avoid waste of storage resources caused by multiple caching of the same training dataset.

It should also be noted that if the training task configuration information inputted by the user includes a configuration update instruction, it indicates that the training dataset stored in the remote data center is updated, and the training dataset cached in the current node or shared storage space is before the update. Therefore, after the training task is created, the cached training dataset may alternatively be incrementally updated based on the dataset stored in the remote data center, then a relationship table of datasets, including information such as names, storage locations, sizes, and paths of the datasets, may be established in advance, the relationship table is updated based on the updated training dataset, and subsequent task training is performed based on the updated training dataset.

In addition, if there is no virtual group with the cached training dataset among the virtual groups, or if there is no node satisfying the quantity of computing resources in the virtual group with the cached training dataset, step S140 is performed to determine whether there are first nodes satisfying the task configuration conditions among the nodes of the AI training platform, so as to select the target node, create the training task, obtain the training dataset from the remote data center and cache the same.

Further, after determining whether there are first virtual groups with shared storage spaces satisfying the size of the training dataset among the virtual groups, the method may further include:

if there is no first virtual group, reconfiguring the shared storage space of each virtual group according to the size of the training dataset to update the shared storage space of the virtual group.

It should be noted that when it is determined that all nodes in the AI training platform do not satisfy the task configuration conditions and the shared storage space of each virtual group does not satisfy the size of the training dataset, the shared storage space of the virtual group may further be dynamically adjusted according to the size of the training dataset in the embodiment of the present application, that is, the shared storage space of the virtual group may be reconfigured, to ensure that the reconfigured shared storage space satisfies the size of the training dataset. In some embodiments, the shared storage space of the virtual group in which the computing resources of a node satisfy the quantity of resources may be configured. If there is a plurality of virtual groups in which the computing resources of a node satisfy the quantity of resources, the shared storage space of one or more of the virtual groups may be reconfigured according to an actual requirement.

After the shared storage space of the virtual group is reconfigured, the step of determining whether there are first virtual groups with shared storage spaces satisfying the size of the training dataset among the virtual groups may be returned, so as to rediscover the first virtual groups satisfying requirements for shared storage spaces and create the AI training task subsequently.

Further, the process of reconfiguring the shared storage space of each virtual group according to the size of the training dataset to update the shared storage space of the virtual group may be as follows:
resetting the preset quota according to the size of the training dataset, and reconfiguring the shared storage space of the virtual group according to the new preset quota to update the shared storage space of the virtual group.

It may be understood that when the shared storage space of the virtual group is reconfigured, the preset quota of the node may be reset, that is, a new preset quota may be set, and the disk space of each node in the virtual group may be divided according to the new preset quota, whereby the disk space, forming the shared storage space, of each node may be increased according to the new preset quota to further increase the size of the shared storage space of the virtual group, so as to successfully create the AI training task.

In addition, the foregoing process of reconfiguring the shared storage space of each virtual group according to the size of the training dataset to update the shared storage space of the virtual group may alternatively be as follows:
adding a new node to the virtual group according to the size of the training dataset, and dividing a preset quota of disk space from the new node to the shared storage space of the virtual group to update the shared storage space of the virtual group.

It should be noted that in addition to the foregoing method for reconfiguring the shared storage space of the virtual group, the new node may be added to the virtual group, whereby the shared storage space of the virtual group might satisfy the requirement for the size of the training data after the preset quota of disk space of the new node is incorporated to the shared storage space of the virtual group.

In practical applications, a step of re-dividing the nodes of the entire AI platform into virtual groups may alternatively be performed.

It should also be noted that in practical applications, the shared storage space of the virtual group may be reconfigured by modifying a dfs configuration file, and then a master node of the dfs may be further restarted to reload the training task configuration information and create a specific AI training task.

In addition, dividing the nodes in the AI platform into a plurality of virtual groups in the embodiment of the present application might also improve the utilization of computing resources. For example, in existing technologies, AI platform nodes are usually configured as a plurality of GPU cards, such as 4 or 8. When an AI training task is created, if the storage space of a node specified by the user is insufficient and the node has remaining computing resources, because the AI training task cannot be created on the node due to insufficient storage space, the remaining computing resources on the node cannot be utilized, leading to waste of expensive resources such as GPU on the node. In the embodiment of the present application, the nodes in the AI platform are divided into a plurality of virtual groups, each virtual group has a shared storage space, a training dataset may be cached through the shared storage space of the first virtual group satisfying the size of the training dataset, and the training task may be created on a second node with computing resources satisfying a requirement in the first virtual group, thereby improving the utilization of computing resources.

In the method, after training task configuration information inputted by a user is received, task configuration conditions are determined according to the training task configuration information, the task configuration conditions including a size of a training dataset and a quantity of computing resources. Then, first nodes satisfying the task configuration conditions are determined and selected from the nodes of the AI training platform, then a target node is selected from the first nodes according to a preset filtering method, a corresponding training task is created on the target node, and the corresponding training dataset is obtained from a remote data center and cached into the storage space of the target node. The present application might avoid a problem of task creation failure caused by insufficient storage space of a specified node during use, and is beneficial to improving creation efficiency of a training task and user experience.

On the basis of the foregoing embodiment, an embodiment of the present application correspondingly provides an apparatus for creating a training task on an AI training platform, as shown in FIG. 3. The apparatus includes:
a first division module 21, configured to divide nodes of the AI training platform into a plurality of virtual groups in advance according to one or more of switch information of the nodes, local area network information, a total quantity of the nodes, and an application dataset;
a second division module 22, configured to divide a preset quota of disk space from each node to form a shared storage space of each virtual group, where each shared storage space corresponds to a distributed caching system;
a receiving module 23, configured to receive training task configuration information inputted by a user, and determine task configuration conditions according to the training task configuration information, the task configuration conditions including a size of a training dataset and a quantity of computing resources;
a determination module 24, configured to determine whether there are first nodes satisfying the task configuration conditions among the nodes of the AI training platform, and if so, trigger a selection module 25;
the selection module 25, configured to select a target node from the first nodes according to a preset filtering method;
a creation module 26, configured to create a corresponding training task on the target node according to the training task configuration information, and obtain the corresponding training dataset from a remote data center according to a remote storage path corresponding to the training dataset in the training task configuration information; and
a caching module 27, configured to cache the training dataset into an independent storage space of the target node, and record a storage path of the training dataset in the independent storage space of the target node, the independent storage space being a remaining disk space divided from the disk space beyond the preset quota of disk space.

It should be noted that the apparatus for creating a training task on an AI training platform according to the embodiment of the present application has the same beneficial effects as the method for creating a training task on an AI training platform in the foregoing embodiment. Refer to the foregoing embodiment for the specific introduction of the method for creating a training task on an AI training platform, involved in the embodiment of the present application. Details are not repeated here in the present application.

On the basis of the foregoing embodiments, an embodiment of the present application further provides a system for creating a training task on an AI training platform. The system includes:
a memory, configured to store a computer program; and
a processor, configured to implement the steps of the foregoing method for creating a training task on an AI training platform when executing the computer program.

For example, the processor in this embodiment is in some embodiments configured to divide nodes of the AI training platform into a plurality of virtual groups in advance according to one or more of switch information of the nodes, local area network information, a total quantity of the nodes, and an application dataset; divide a preset quota of disk space from each node to form a shared storage space of each virtual group, where each shared storage space corresponds to a distributed caching system; receive training task configuration information inputted by a user, and determine task configuration conditions according to the training task configuration information, the task configuration conditions including a size of a training dataset and a quantity of computing resources; determine whether there are first nodes satisfying the task configuration conditions among the nodes of the AI training platform, and if so, select a target node from the first nodes according to a preset filtering method; create a corresponding training task on the target node according to the training task configuration information, and obtain the corresponding training dataset from a remote data center according to a remote storage path corresponding to the training dataset in the training task configuration information; and cache the training dataset into an independent storage space of the target node, and record a storage path of the training dataset in the independent storage space of the target node, the independent storage space being a remaining disk space divided from the disk space beyond the preset quota of disk space.

On the basis of the foregoing embodiments, an embodiment of the present application further provides a computer-readable storage medium, where the computer-readable storage medium stores a computer program, and the steps of the foregoing method for creating a training task on an AI training platform are implemented when the computer program is executed by a processor.

The computer-readable storage medium may include various media capable of storing program code, such as a U disk, a mobile hard disk, a read-memory (ROM), a random access memory (RAM), a magnetic disk, or an optical disk.

The embodiments in this specification are all described in a progressive manner. The description of each of the embodiments focuses on differences from other embodiments, and reference may be made to each other for the same or similar parts among respective embodiments. The apparatus disclosed in the embodiment corresponds to the method disclosed in the embodiment and is thus described relatively simply, and reference may be made to the description of the method for the related parts.

It should be further noted that in this specification, relational terms such as “first” and “second” are only used to distinguish one entity or operation from another, and do not necessarily require or imply that any actual relationship or sequence exists between these entities or operations. Moreover, the terms “include” and “contain”, or any of their variants are intended to cover a non-exclusive inclusion, whereby a process, method, article, or device that includes a series of elements not only includes those elements but also includes other elements that are not expressly listed, or further includes elements inherent to such process, method, article, or device. In the absence of more limitations, an element defined by “include a . . . ” does not exclude other same elements existing in the process, method, article, or device including the element.

The foregoing descriptions of the disclosed embodiments enable those skilled in the art to implement or use the present application. Various modifications to these embodiments are obvious to those skilled in the art, and the general principles defined herein may be implemented in other embodiments without departing from the spirit or scope of the present application. Therefore, the present application will not be limited to the embodiments shown herein, but conforms to the widest scope consistent with the principle and novelty disclosed herein.

1. A method for creating a training task on an Artificial Intelligence (AI) training platform, comprising:
dividing nodes of the AI training platform into a plurality of virtual groups in advance according to one or more of switch information of the nodes, local area network information, a total quantity of the nodes, and an application dataset;
dividing a preset quota of disk space from each of the nodes to form a shared storage space of each of the virtual groups, wherein each shared storage space corresponds to a distributed caching system;
receiving training task configuration information inputted by a user, and determining task configuration conditions according to the training task configuration information, the task configuration conditions comprising a size of a training dataset and a quantity of computing resources;
determining whether there are first nodes satisfying the task configuration conditions among the nodes of the AI training platform, and in response to there being first nodes satisfying the task configuration conditions among the nodes of the AI training platform, selecting a target node from the first nodes according to a preset filtering method;
creating a corresponding training task on the target node according to the training task configuration information, and obtaining the corresponding training dataset from a remote data center according to a remote storage path corresponding to the training dataset in the training task configuration information; and
caching the training dataset into an independent storage space of the target node, and recording a storage path of the training dataset in the independent storage space of the target node, the independent storage space being a remaining disk space divided from the disk space beyond the preset quota of disk space.

2. The method for creating a training task on an AI training platform according to claim 1, wherein after the determining that none of the nodes in the AI training platform satisfy the task configuration conditions, the method further comprises:
determining whether there are first virtual groups with shared storage spaces satisfying the size of the training dataset among the virtual groups, and in response to there being the first virtual groups among the virtual groups, determining whether there are second nodes with computing resources satisfying the quantity of computing resources among the first virtual groups;
in response to there being the second nodes, using the virtual groups corresponding to the second nodes as second virtual groups, and selecting a target virtual group from the second virtual groups; and
when there is one of the second nodes in the target virtual group, using the one of the second nodes in the target virtual group as the target node, obtaining the corresponding training dataset from the remote data center through the corresponding distributed caching system, and caching the training dataset into the shared storage space of the target virtual group; or
when there is a plurality of the second nodes in the target virtual group, using a second node with a quantity of remaining computing resources closest to the quantity of computing resources in the task configuration conditions among the plurality of the second nodes in the target virtual group as the target node, obtaining the corresponding training dataset from the remote data center through the corresponding distributed caching system, and caching the training dataset into the shared storage space of the target virtual group.

3. The method for creating a training task on an AI training platform according to claim 1, wherein the determining whether there are first nodes satisfying the task configuration conditions among the nodes of the AI training platform comprises is as follows:
determining whether there are nodes with independent storage spaces satisfying the size of the training dataset among the nodes of the AI training platform, and in response to there being nodes with independent storage spaces satisfying the size of the training dataset among the nodes of the AI training platform, determining whether there are first nodes with computing resources satisfying the quantity of computing resources among the nodes satisfying the size of the training dataset.

4. The method for creating a training task on an AI training platform according to claim 3, wherein the selecting a target node from the first nodes according to a preset filtering method comprises:
comparing the independent storage space of each of the first nodes with the size of the training dataset, and selecting a first node with the independent storage space closest to the size of the training dataset, as the target node.

5. The method for creating a training task on an AI training platform according to claim 1, wherein before the determining whether there are first nodes satisfying the task configuration conditions among the nodes of the AI training platform, the method further comprises:
determining whether the training dataset is cached in the independent storage space of each of the nodes of the AI training platform, in response to the training dataset being cached in the independent storage space of each of the nodes of the AI training platform, selecting the target node satisfying the quantity of computing resources from the nodes with a cached training dataset, and creating the training task on the target node; in response to the training dataset being not cached in the independent storage space of each of the nodes of the AI training platform, determining whether the training dataset is cached in the shared storage space of each of the virtual group, in response to there being a virtual group with the cached training dataset, determining whether there are nodes satisfying the quantity of computing resources from the nodes of the virtual group with the cached training dataset, in response to there being nodes satisfying the quantity of computing resources from the nodes of the virtual group with the cached training dataset, selecting the target node from the nodes satisfying the quantity of computing resources, and creating the training task on the target node; or in response to there being no virtual group with the cached training dataset or no node satisfying the quantity of computing resources, determining whether there are first nodes satisfying the task configuration conditions among the nodes of the AI training platform.

6. The method for creating a training task on an AI training platform according to claim 2, wherein after the determining whether there are first virtual groups with shared storage spaces satisfying the size of the training dataset among the virtual groups, the method further comprises:
in response to there being no first virtual group, reconfiguring the shared storage space of one or more of the virtual groups according to the size of the training dataset to update the shared storage space of one or more of the virtual groups.

7. The method for creating a training task on an AI training platform according to claim 6, wherein the reconfiguring the shared storage space of one or more of the virtual groups according to the size of the training dataset to update the shared storage space of one or more of the virtual groups comprises:
resetting the preset quota according to the size of the training dataset, and reconfiguring the shared storage space of one or more of the virtual groups according to a new preset quota to update the shared storage space of one or more of the virtual groups.

8. The method for creating a training task on an AI training platform according to claim 6, wherein the reconfiguring the shared storage space of one or more of the virtual groups according to the size of the training dataset to update the shared storage space of one or more of the virtual groups comprises:
adding a new node to one or more of the virtual groups according to the size of the training dataset, and dividing a preset quota of disk space from the new node to the shared storage space of the one or more of the virtual groups to update the shared storage space of the one or more of the virtual groups.

9. (canceled)

10. A system for creating a training task on an Artificial Intelligence (All training platform, comprising:
a memory storing a computer program; and
a processor, configured to execute the computer program, wherein upon execution of the computer program, the processor is configured to:
divide nodes of the AI training platform into a plurality of virtual groups in advance according to one or more of switch information of the nodes, local area network information, a total quantity of the nodes, and an application dataset;
divide a preset quota of disk space from each of the nodes to form a shared storage space of each of the virtual groups, wherein each shared storage space corresponds to a distributed caching system;
receive training task configuration information inputted by a user, and determine task configuration conditions according to the training task configuration information, the task configuration conditions comprising a size of a training dataset and a quantity of computing resources;
determine whether there are first nodes satisfying the task configuration conditions among the nodes of the AI training platform, and in response to there being first nodes satisfying the task configuration conditions among the nodes of the AI training platform, select a target node from the first nodes according to a preset filtering method;
create a corresponding training task on the target node according to the training task configuration information, and obtain the corresponding training dataset from a remote data center according to a remote storage path corresponding to the training dataset in the training task configuration information; and
cache the training dataset into an independent storage space of the target node, and record a storage path of the training dataset in the independent storage space of the target node, the independent storage space being a remaining disk space divided from the disk space beyond the preset quota of disk space.

11. A non-transitory computer-readable storage medium, storing a computer program executable by a processor, wherein upon execution by the processor, the computer program is configured to cause the processor to:
divide nodes of an Artificial Intelligence (AI) training platform into a plurality of virtual groups in advance according to one or more of switch information of the nodes, local area network information, a total quantity of the nodes, and an application dataset;
divide a preset quota of disk space from each of the nodes to form a shared storage space of each of the virtual groups, wherein each shared storage space corresponds to a distributed caching system;
receive training task configuration information inputted by a user, and determining task configuration conditions according to the training task configuration information, the task configuration conditions comprising a size of a training dataset and a quantity of computing resources;
determine whether there are first nodes satisfying the task configuration conditions among the nodes of the AI training platform, and in response to there being first nodes satisfying the task configuration conditions among the nodes of the AI training platform, select a target node from the first nodes according to a preset filtering method;
create a corresponding training task on the target node according to the training task configuration information, and obtain the corresponding training dataset from a remote data center according to a remote storage path corresponding to the training dataset in the training task configuration information; and
cache the training dataset into an independent storage space of the target node, and record a storage path of the training dataset in the independent storage space of the target node, the independent storage space being a remaining disk space divided from the disk space beyond the preset quota of disk space.

12. The system according to claim 10, wherein after the determining that none of the nodes in the AI training platform satisfy the task configuration conditions, the processor, upon execution of the computer program, is further configured to:
determine whether there are first virtual groups with shared storage spaces satisfying the size of the training dataset among the virtual groups, and in response to there being the first virtual groups among the virtual groups, determine whether there are second nodes with computing resources satisfying the quantity of computing resources among the first virtual groups;
in response to there being the second nodes, use the virtual groups corresponding to the second nodes as second virtual groups, and select a target virtual group from the second virtual groups; and
when there is one of the second nodes in the target virtual group, use the one of the second nodes in the target virtual group as the target node, obtain the corresponding training dataset from the remote data center through the corresponding distributed caching system, and cache the training dataset into the shared storage space of the target virtual group; or
when there is a plurality of the second nodes in the target virtual group, use a second node with a quantity of remaining computing resources closest to the quantity of computing resources in the task configuration conditions among the plurality of the second nodes in the target virtual group as the target node, obtain the corresponding training dataset from the remote data center through the corresponding distributed caching system, and cache the training dataset into the shared storage space of the target virtual group.

13. The system according to claim 10, wherein in order to determine whether there are first nodes satisfying the task configuration conditions among the nodes of the AI training platform, the processor, upon execution of the computer program, is configured to:
determine whether there are nodes with independent storage spaces satisfying the size of the training dataset among the nodes of the AI training platform, and in response to there being nodes with independent storage spaces satisfying the size of the training dataset among the nodes of the AI training platform, determine whether there are first nodes with computing resources satisfying the quantity of computing resources among the nodes satisfying the size of the training dataset.

14. The system according to claim 13, wherein in order to select a target node from the first nodes according to a preset filtering method, the processor, upon execution of the computer program, is configured to:
compare the independent storage space of each of the first nodes with the size of the training dataset, and select a first node with the independent storage space closest to the size of the training dataset, as the target node.

15. The system according to claim 10, wherein the processor, upon execution of the computer program, is further configured to:
determine whether the training dataset is cached in the independent storage space of each of the nodes of the AI training platform, in response to the training dataset being cached in the independent storage space of each of the nodes of the AI training platform, select the target node satisfying the quantity of computing resources from the nodes with a cached training dataset, and create the training task on the target node; in response to the training dataset being not cached in the independent storage space of each of the nodes of the AI training platform, determine whether the training dataset is cached in the shared storage space of each of the virtual groups, in response to there being a virtual group with the cached training dataset, determine whether there are nodes satisfying the quantity of computing resources from the nodes of the virtual group with the cached training dataset, in response to there being nodes satisfying the quantity of computing resources from the nodes of the virtual group with the cached training dataset, select the target node from the nodes satisfying the quantity of computing resources, and create the training task on the target node; or in response to there being no virtual group with the cached training dataset or no node satisfying the quantity of computing resources, determine whether there are first nodes satisfying the task configuration conditions among the nodes of the AI training platform.

16. The system according to claim 12, wherein after determining whether there are first virtual groups with shared storage spaces satisfying the size of the training dataset among the virtual groups, the processor, upon execution of the computer program, is further configured to:
in response to there being no first virtual group, reconfigure the shared storage space of one or more of the virtual groups according to the size of the training dataset to update the shared storage space of one or more of the virtual groups.

17. The system according to claim 16, wherein in order to reconfigure the shared storage space of one or more of the virtual groups according to the size of the training dataset to update the shared storage space of one or more of the virtual groups, the processor, upon execution of the computer program, is configured to:
reset the preset quota according to the size of the training dataset, and reconfigure the shared storage space of one or more of the virtual groups according to a new preset quota to update the shared storage space of one or more of the virtual groups.

18. The system according to claim 16, wherein in order to reconfigure the shared storage space of one or more of the virtual groups according to the size of the training dataset to update the shared storage space of one or more of the virtual groups, the processor, upon execution of the computer program, is configured to:
add a new node to one or more of the virtual groups according to the size of the training dataset, and divide a preset quota of disk space from the new node to the shared storage space of the one or more of the virtual groups to update the shared storage space of the one or more of the virtual groups.

19. The method for creating a training task on an AI training platform according to claim 1, wherein the dividing nodes of the AI training platform into a plurality of virtual groups in advance according to one or more of switch information of the nodes, local area network information, a total quantity of the nodes, and an application dataset comprises:
dividing the nodes that are located in a same local area network and disposed on a same switch into a same virtual group; or
selecting some of the nodes according to a size of the application dataset, and dividing the some of the nodes into a same virtual group.

20. The method for creating a training task on an AI training platform according to claim 1, the method further comprises:
mounting the distributed caching system to each node in the respective virtual groups through filesystem in user space (FUSE).

21. The method for creating a training task on an AI training platform according to claim 2, the method further comprises:
in response to a remaining space of the shared storage space of each of the virtual groups not satisfying the size of the training dataset, or in response to each node in each of the second virtual groups not satisfying the quantity of computing resources, returning a reminder message about training task creation failure.
